(19) United States
(12) Patent Application Publication
(10) Pub. No.: US 2007/0094039 A1
(43) Pub. Date: Apr. 26, 2007

(54) Methods and systems of monitoring child welfare and juvenile justice services

(76) Inventors: Mary S. Grant, Oakton, VA (US); Felipe A. Custer, Washington, DC (US); Daniel Klein, Silver Spring, MD (US); Susan Colwell, Shrewsbury, MA (US)

Correspondence Address: Gerard P. Norton;NORTON & DIEHL LLC, Suite 110, 77 Brant Ave., Clark, NJ, 07066, US

(21) Appl. No.: 11/255,441

(22) Filed: Oct. 21, 2005

(51) Int. Cl. G06Q 99/00

(52) U.S. Cl. 705/1

(57) ABSTRACT

A method and system of collecting, evaluating, and sharing information about the status of at least one child under the auspices of a child welfare agency, a juvenile justice agency or another responsible agency that comprises: enabling various individuals to asynchronously submit structured and unstructured information about a child through a multi-channel, password-protected interface; storing information about the identity, characteristics, and status of a plurality of children in a database memory or registry; automatically evaluating and prioritizing information about a status of a child according to predefined rules; providing a password-protected interface through the Internet to the memory for a child welfare worker, juvenile justice worker, other responsible agency worker, or collateral personnel; providing detailed and summary information about an individual child among the plurality of children, and about aggregate groupings of children through the password-protected interface; and facilitating the sharing of information and the communication about a status of at least one child among child welfare workers, juvenile justice workers, other responsible agency workers, and collateral personnel.

### BACKGROUND OF THE INVENTION

The present invention relates to methods and systems for monitoring juveniles by members of social service divisions.

The youth served by social service programs and the social service institutions themselves have many similar obstacles to success. Low incomes, educational challenges, family stresses, limited community resources are common to the youth in both populations. Social services institutions have limited resources, high case loads, complex communication needs, poor access to centralized data, limited access to up-to-date technology and complex documentation requirements from funding sources. The social service institutions of primary concern are departments that implement child welfare and juvenile justice functions.

Youth come to the attention of Child Welfare and Juvenile Justice Institutions in very different ways. Child Welfare agencies play a child protective service role, taking custody of children and youth judged at-risk. Juvenile Justice Agencies play a rehabilitation and community safety role, providing supervision of identified youth in order to protect the community. Because of these differences, first the issues will be reviewed separately for the two groups, and then common system issues will be addressed.

The nation's combined federal, state and local adult correctional population reached a new record of almost 6.9 million men and women in 2003, an increase of 130,700 people since Dec. 31, 2002, according to the Justice Department's Bureau of Justice Statistics (BJS). The juvenile justice numbers are keeping pace with the adult figures. In 2000, courts with juvenile jurisdiction disposed more than 1.6 million delinquency cases. The number of cases in which youth were placed on formal probation or ordered to a residential facility increased substantially between 1985 and 2000. Youth in 24% (91 of 382) of adjudicated delinquency cases were placed in residential facilities. In another 63% (241 of 382) of these adjudicated cases, youth were placed on formal probation.

Juvenile probation is used by juvenile justice agencies at many different points in the system. It serves as a sanction for juveniles adjudicated in court, and as a way of diverting status offenders or first-time juvenile offenders from the court system. Some communities use probation to informally monitor at-risk youth and prevent more serious problem behavior. With such varied uses, probation touches large numbers of juveniles. In 2000, an estimated 658,800 delinquency cases resulted in a term of probation—54% above the number of cases placed on probation in 1985.

Adjudicated delinquents accounted for 60% (393,300) of all delinquency cases placed on probation in 2000. In the remaining delinquency cases, the youth agreed to some form of voluntary or informal probation. Monitoring and supporting youth who are placed on probation for any of the above reasons is a complex operation with high stakes for the youth and the community.

According to the Office of Juvenile Justice and Delinquency Prevention of the Department of Justice (OJJDP), youth who are released from institutional confinement are more likely to succeed if they have access to services that can help them thrive in a non-institutional environment. When high-quality reentry and aftercare services are available, youth need to spend less time in confinement, and the overall cost of juvenile corrections can be reduced. Furthermore, the most effective reentry/aftercare programs begin before a youth leaves the facility and involve the family and the community. Lastly, there needs to be a reporting system with the capacity to hear from youth as well as service providers, family members and other adults identified by youth in order to provide advance warning of crises, connections for the youth to each other and to caring, responsible adults.

Child welfare services in the United States impact large numbers of abused and neglected children and their families, requiring billions of dollars of funding. Out-of-home care is an intervention with complex decision- making implications for the health, safety, and well being of children at-risk. According to the analysis of the National Adoption and Foster Care Reporting System (AFCARS), in FY2002 (last year figures are available) 813,000 children were served. This is based on reports by the states to the Children's Bureau and includes all children served during the year, not just those being served at one point in time.

Child maltreatment is a chronic, national issue affecting children in all 50 states. The stakes are high when dealing with suspected abuse and neglect. The National Child Abuse and Neglect Data System (NCANDS) reported an estimated 1,400 child fatalities in 2002 caused by an injury resulting from abuse or neglect, or where abuse or neglect were contributing factors. Many researchers and practitioners believe that child fatalities due to abuse and neglect are underreported for several reasons. States have varying definitions, investigations are not always comprehensive and coding of abuse on death certificates is not uniform across the states. While the exact number of children affected is uncertain, child fatalities due to abuse and neglect remain a serious problem in the United States.

Both Child welfare and juvenile justice agencies have been challenged by these issues and the growing numbers of children and families in crises in the past 20 years. Resources and tools to address the complex issues faced have not kept pace with the growth in populations served.

Accordingly, there is an urgent and profound need for a tightly integrated Internet and telephone-based solution for efficiently collecting, evaluating, and sharing timely information about the status of children under the auspices of child welfare, juvenile justice, and other responsible agencies. Such a solution would significantly augment existing case management and service delivery efforts throughout the child welfare and juvenile justice arenas.

### SUMMARY OF THE INVENTION

The present invention fills the foregoing and other needs by providing a method and system of collecting, evaluating, and sharing information about the status of at least one child under the auspices of a child welfare agency, a juvenile justice agency or another responsible agency that comprises: enabling various individuals to asynchronously submit structured and unstructured information about a child through a multi-channel, password-protected interface; storing information about the identity, characteristics, and status of a plurality of children in a database memory or registry; automatically evaluating and prioritizing information about a status of a child according to predefined rules; providing a password-protected interface through the Internet to the memory for a child welfare worker, juvenile justice worker, or other responsible agency worker; providing detailed and summary information about an individual child among the plurality of children, and about aggregate groupings of children through the password-protected interface; facilitating the sharing of information and the communication about a status of at least one child among child welfare workers, juvenile justice workers, other responsible agency workers, and collateral personnel.

In accordance with one aspect of the present invention, a method of collecting, evaluating and sharing information about a plurality of children is provided. An interface to enter information relating to one of the plurality of children is provided. The entered information is stored in a database or other memory device on a server. The entered information is processed to determine an issue relating to the one of the plurality of children. The issue identifies a potential problem for the child. The processor generates a notice and notifies one or more social services departments of the issue.

The notice is preferably provided over a network. In accordance with a preferred embodiment of the present invention, the notice about the issue is provided via the Internet.

In accordance with another aspect of the present invention, the interface is provided by phone, by wireless, and by the internet. The notice can be sent to a parent or guardian of the one of the plurality of children to advise them about the issue. In accordance with another aspect of the invention, one social services department can communicate with another social services department about the notice, the issue or about any other aspect of a child's care in a social services department.

The method of the present invention also includes the step of generating a report summarizing the status of the plurality of children. This report also preferably identifies which of the plurality of children have a priority issue and is graphically presented. In accordance with one aspect of the present invention, the report is transmitted via a network, such as the Internet, to a case manager. The report can also be sent to any of the social services departments connected to the server via the network or Internet. By way of example only, the report can be transmitted to the juvenile justice department. The report can also be transmitted to other responsible agencies. These agencies include, without limitation, Family Court, Dependency Court, Child Protective Services, Child Welfare Agencies, and Foster Care Agencies.

In accordance with another aspect of the present invention, the interface provides a questionnaire about the status of one of the plurality of children to any of the social services departments.

The present invention also contemplates providing a system for collecting, evaluating and sharing information about a plurality of children. The system includes a server and a database, the server being connected to a network such as the Internet. The system has a plurality of client terminals connected to the network. A first software application through which information relating to one of the plurality of children can be entered through one or more of the plurality of client terminals into the database and a second software application that processes the information to determine an issue relating to the one of the plurality of children are provided. The software applications can either be stored on the client terminals or can be server based applications that are downloaded by the client terminals when needed.

The invention will now be further described in connection with certain illustrated embodiments; however, it should be clear to those skilled in the art that various modifications, additions and subtractions can be made without departing from the spirit and scope of the claims.

### BRIEF DESCRIPTION OF THE DRAWINGS

FIG. 1 illustrates a diagram of a networked system in accordance with one aspect of the present invention.

FIG. 2 shows a schematic diagram of a number of different password-protected, role-based menus that are provided for various users of the system based upon their particular individual and organizational roles.

FIG. 3 illustrates a table of users and the applications they can access in accordance with one aspect of the present invention.

FIG. 4 illustrates a diagram of the infrastructure of the system of the present invention in accordance with another aspect of the present invention.

FIG. 5 illustrates the system of the present invention in accordance with another aspect of the present invention.

FIG. 6 illustrates a rules engine that analyzes information provided by the interfaces of the present invention to generate reports that indicate, among other things, issues relating to one or more children.

FIG. 7 illustrates the rules engine in accordance with one aspect of the present invention.

FIGS. 8 to 13 illustrate a questionnaire provided by the interfaces of the present system in accordance with one aspect of the present invention.

FIG. 14 illustrates a summary of responses to the questionnaire in accordance with one aspect of the present invention.

FIG. 15 illustrates a graphical report card provided by the present system in accordance with a further aspect of the present invention.

FIG. 16 illustrates a home page for a case worker provided by the system of the present invention.

FIG. 17 illustrates a home page for a foster parent provided by the system of the present invention.

FIG. 18 illustrates a graphical user interface for displaying the identity, characteristics, and status of at least one child among a plurality of children to a child welfare worker, juvenile justice worker, or other responsible agency worker.

FIG. 19 illustrates the interaction between family members and social services case workers in accordance with one aspect of the present invention.

FIG. 20 illustrates the interaction between collateral personnel and social services case workers in accordance with one aspect of the present invention.

### DETAILED DESCRIPTION

To aid in the understanding of the invention, the following non-limiting definitions are provided:

As used herein, a “child welfare system” shall mean a system of providing social services, including, without limitation, the following: a) working with families to keep children safely in their homes; b) placing children out of their homes when necessary; c) developing service plans to re-unite the children with their families. The child welfare system encompasses various agencies, organizations and individuals, including but not limited to the juvenile justice system, the probation system, police departments, schools, and social services departments. Family courts, public-sector and private-sector child welfare agencies, child protective services, residential facilities, group homes, foster care providers, child advocates and case workers are included.

The term “juvenile justice system” shall mean a system responsible for adjudicating and rehabilitating delinquent youth. The juvenile justice system encompasses various agencies, organizations and individuals including but not limited to delinquency courts, family courts, residential facilities, community-based programs and probation officers.

The term “information about the status” of a child shall mean at least one of the following: a) information relevant to the identification of a child; b) information relevant to protection and promotion of a child's welfare; c) information relevant to prevention, or remedying, or assistance in the solution of problems which may result in the neglect, abuse, exploitation, or delinquency of a child; d) information relevant to prevention of the unnecessary separation of a child from his or her family by identifying the family's problem, assisting the family in resolving that problem, and preventing breakup of the family where the prevention of the child's removal is desirable and possible; e) information relevant to restoring a child to his or her family, if the child has been removed, by the provision of services to the child and the family; f) information relevant to placing a child in a suitable adoptive home, in cases where restoration to a biological family of the child is not possible or appropriate; g) information relevant to assuring adequate care of a child away from his or her home, in cases where the child cannot be returned to his or her home or cannot be placed for adoption; h) information relevant to a child's ability to legally enter or reside in a particular country; or i) information relevant to reducing youth violence, truancy, involvement in criminal gangs, substance abuse and other delinquent behavior.

The term “child welfare worker” shall mean an individual, whose responsibilities include providing social services and assistance to improve the social and psychological functioning of children and their families and to maximize the family well-being and academic functioning of children.

The term “juvenile justice worker” shall mean a probation officer or other court-appointed individual who represents the best interests of a child and whose responsibilities include: a) assessing the child's needs and wishes with regard to the representation, monitoring the implementation of court orders and determination whether services ordered by the court for the child or the child's family are being provided in a timely manner and are accomplishing their purpose; and b) informing the court if the services are not being provided in a timely manner, if the family fails to take advantage of these services, or if the services are not accomplishing their purpose.

The term “other responsible agency worker” shall mean an individual other than a child welfare worker or juvenile justice worker, whose responsibilities include welfare, protection, adjudication, removal, custody, or containment of minor children and youth.

The term “collateral personnel” shall mean individuals who are involved with a child welfare or juvenile justice case in a supportive capacity, but who are not child welfare workers, juvenile justice workers or other responsible agency workers duly assigned to the case. Examples of collateral personnel include but are not limited to teachers, school counselors, coaches, health care providers, mental health care providers and court appointed special advocates (CASA's).

The term “family member” shall mean a child who is under the auspices of a child welfare agency, juvenile justice agency or other responsible agency, as well as said child's parents, siblings, foster-parents, and foster-siblings.

The term “participant” shall mean a child welfare worker, a juvenile justice worker, other responsible agency worker, collateral personnel, or a family member.

The term “password” shall mean an access control code that in combination with a unique user identifier (user ID) allows authorized users to gain access to the system. The password may without limitation consist of alphanumeric characters, biometric data, or other unique and secure representations that may be used to provide secure access to the system.

The term “password-protected interface” shall mean a device allowing a person to enter a password into the system and, if the password is correct, to enter and access information about the status of a child, including, without limitations, telephones, cellular telephones, desktop computers, laptop computers, notebook computers, personal digital assistants (PDAs), and other similar devices.

Aspects of the present invention provide a method and system of collecting, evaluating, and sharing information about the status of at least one child under the auspices of a child welfare agency, a juvenile justice agency or another responsible agency that comprises: enabling various individuals to asynchronously submit structured and unstructured information about a child through a multi-channel, password-protected interface; storing information about the identity, characteristics and status of a plurality of children in a database memory or registry; automatically evaluating and prioritizing information about a status of a child according to predefined rules; providing a password-protected interface through the Internet to the memory for a child welfare worker, juvenile justice worker, other responsible agency worker, or collateral personnel; providing detailed and summary information about an individual child among the plurality of children, and about aggregate groupings of children through the password-protected interface; and facilitating the sharing of information and the communication about a status of at least one child among child welfare workers, juvenile justice workers, other responsible agency workers, and collateral personnel.

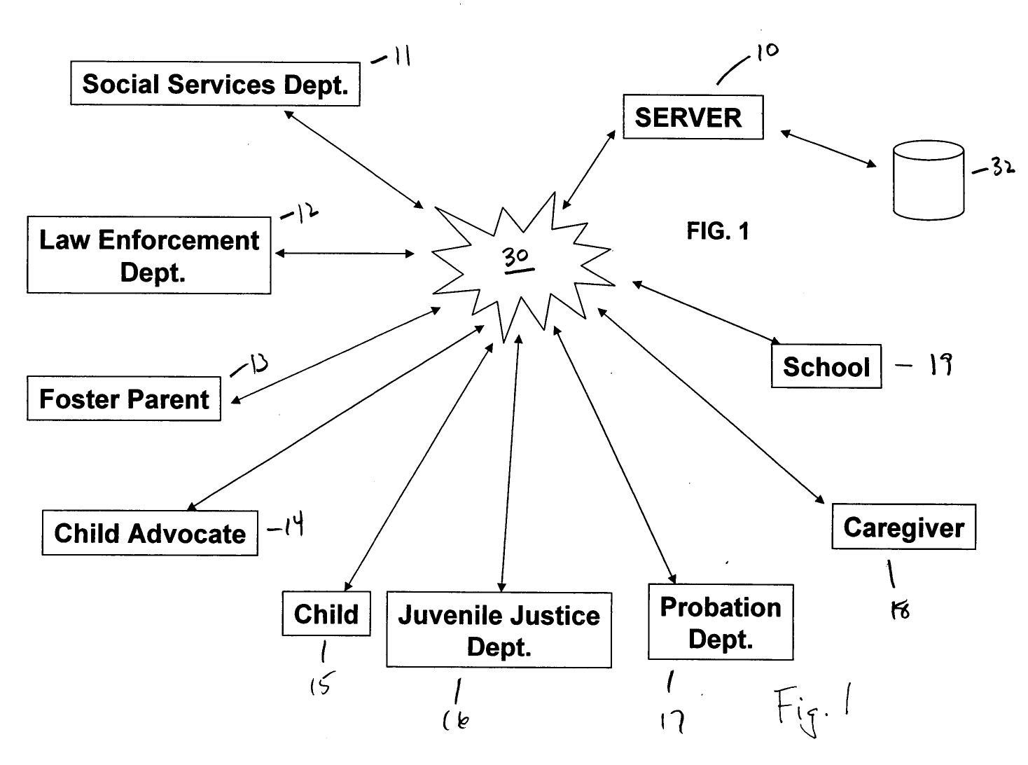

Referring to FIG. 1, a diagram of a networked system in accordance with one aspect of the present invention. A server 10 is connected to a plurality of client terminals 11 to 19 via a network 30. The network 30 is preferably the Internet. A database 32 or other memory device is connected to the server 10.

The client terminals 11 to 19 are preferably provided to all of the organizations and people involved with provided services and care for troubled youth. For example, client terminal 11 is provided to a social services department. All members of the social services department preferably have a password protected access to the server 10 and the database 32. Thus, a plurality of connections may be provided in the social services department, and those connections may be provided by an intranet.

Client terminal 12 provides one or more law enforcement departments with access to the server 10 and the database 32. The access is preferably password protected. As before, one or more members of the law enforcement department can be provided with access, preferably via an intranet or other internal network.

Client terminal 13 is provided to a foster parent. Client terminal 14 is provided to a child advocate. Client terminal 14 is accessed by a troubled child that is part of a child welfare system. The client terminals 13, 14 and 15 may be a personal computer at the foster parent's home or at the child advocate's office or at the child's home. Alternatively, the client terminals 13, 14 and 15 can be a terminal accessed remotely.

Client terminals 16 and 17 provide communications with the child welfare information system of the present invention to other organizations involved with the welfare of the child. Client terminal 16 provides members of one or more juvenile justice departments with password protected access to the server 10 and the database 32. Thus, all of the members of the juvenile justice department can obtain access to the information about one or more troubled children that is contained in the server 10 and the database 32. Client terminal 17 provides members of a probation department with password protected access to the information in the server 10 and the database 32.

Client terminal 18 provides access to a person who cares for a troubled child. That person is termed a caregiver. The caregiver may be a parent, an adoptive parent or other person who cares for a child. The client terminal may be a personal computer or a remote terminal.

Client terminal 19 provides access to a school, preferably via an intranet in the school. Teachers, administrators, guidance personnel and others involved in the schooling of a troubled child can communicate with the server 10 and the database 32.

In accordance with one aspect of the present invention, the various participants and organizations involved with providing for a troubled child in either the child welfare or any social services program are given access to relevant information stored in the database 32 and can also contribute new information to the database 32. This information is useful to improve the status and the care given to that child. Additionally the various participants and organizations involved can communicate with each other.

As will be appreciated, the server 10 may include one or more servers. Individual servers can be designated for certain tasks. For example, an application server can be provided that handles the various applications and application software provided by the system.

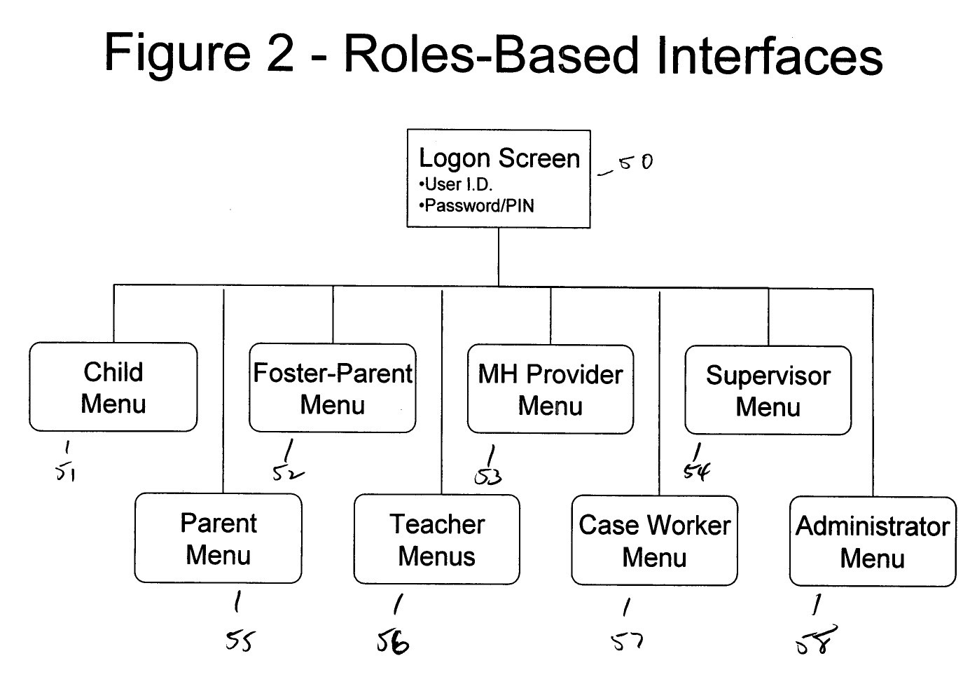

Access to the system is preferably password protected. FIG. 2 illustrates the initial interface to the server 10 provided by the system in accordance with one aspect of the present invention. When a user from one of the client terminals 11 to 19 wants access to the system and the server 10, the user enters the address of the system into one of the client terminals 11 to 19. The client terminal then finds the server 10 on the network 30. Referring to FIG. 2, the server 10 then provides a login screen 50 to the user. The login screen 50 is provided to each of the users of the system, some of which 51 to 58 are indicated in FIG. 2.

In accordance with a preferred embodiment of the present invention, this process is handled by an application server. The login screen inquires as to the user's ID and password. A table of ID's and associated passwords are maintained in the database 32. To gain access to the system, a user must enter a correct ID and associated password.

Access to the system is also preferably dependant on the role of the user in the system. Thus, a user logging in as a foster parent 52 will have different privileges than as user logging in as a case worker 57. The various applications include: home page, dashboard, case management, questionnaire management, resource management, reporting, systems administration; and various platform services including but not limited to messaging, alerting, workflow management, and rules evaluation.

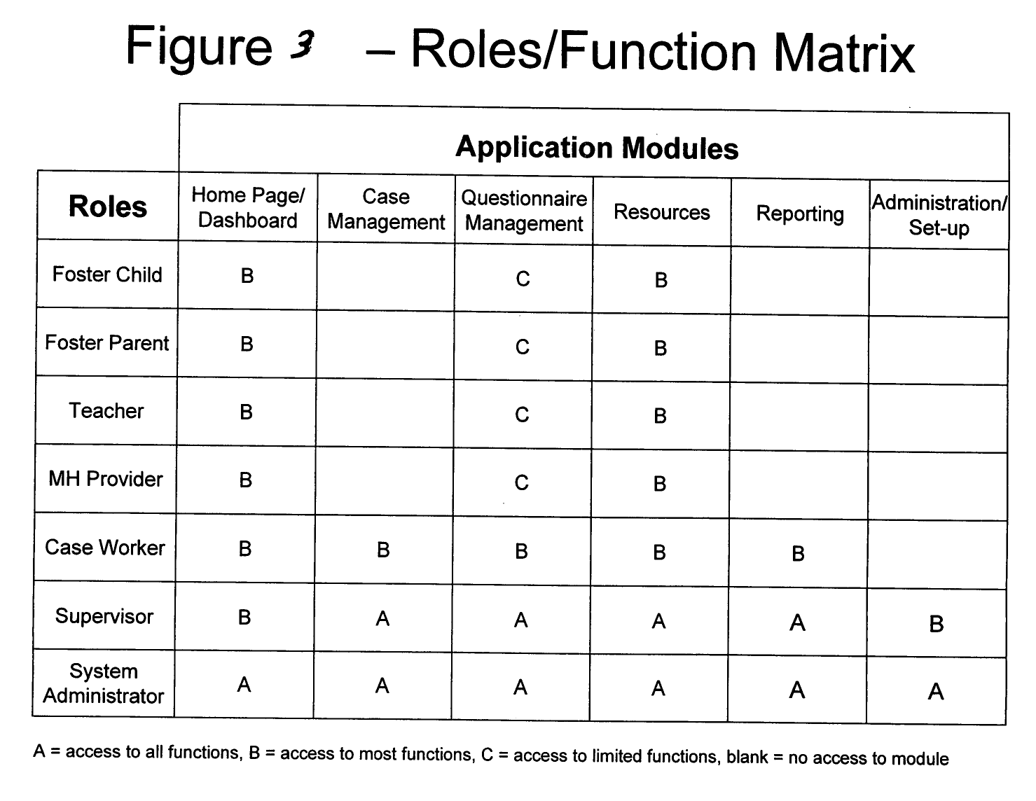

The table in FIG. 3 indicates the various types of users and the various applications they will be granted access to provided they enter a correct ID and password. The applications indicated in FIG. 3 include the Home Page/Dashboard application, the Case Management application, the Questionnaire Management application, the Resources application, the Reporting application, and the Administration/Set-up application. A summary of each of the applications follows.

The Home Page/Dashboard Module provides a summary of key information for each user, including a message center, task calendar, and dashboards displaying the status of critical items. The home page also provides a menu for users to access other functions, subject to their particular roles and permissions. Access to this module is provided to all users, but the system administrator gets full access.

The Case Management Module is used by the caseworker and supervisors to set-up, monitor and manage individual cases. This module allows the caseworker to establish a reporting schedule for all individuals associated with a given case, to monitor the information being reported by children, foster parents, and collateral personnel, to prioritize cases for follow-up, to refer cases to other responsible personnel for additional follow-up and support. Access to this module is provided to the case worker, to the supervisor and to the system administrator. The case worker is limited to accessing information relating to the children they are responsible for. The supervisor is limited to accessing information relating to the children their case worker's are responsible for. The system administrator is granted full access.

The Questionnaire Management Module is used by children, foster parents, and collateral personnel to submit questionnaire data according the schedule established by the caseworker. In addition, caseworkers and supervisors can use this module to add, edit and delete questionnaire forms, including the required question items, possible responses, scoring and alerting rules. Access to this module is provided to all users. Access by children, parents and mental health providers is limited to a particular child. The case worker is limited to accessing information relating to the children they are responsible for. The supervisor is limited to accessing information relating to the children their case worker's are responsible for. The system administrator is granted full access.

The Resources Module provides access to instructions, forms, documents, and links to information that need to be available to various users. Users can view and download this information, subject to their roles and permissions. Also, caseworkers and supervisors can use this module to publish information in a variety of formats as required.

The Reporting Module allows caseworkers and supervisors to create, publish, and view aggregate statistical and graphical reports pertaining to questionnaire data. These reports can be sorted and filtered to meet various requirements. In addition, report data can be exported from this module for further manipulation and analysis.

The Administration/Set-up Module is used by the system administrator to configure the ECHOS system to a particular agency's requirements. It is also used to set-up user accounts, roles and permissions.

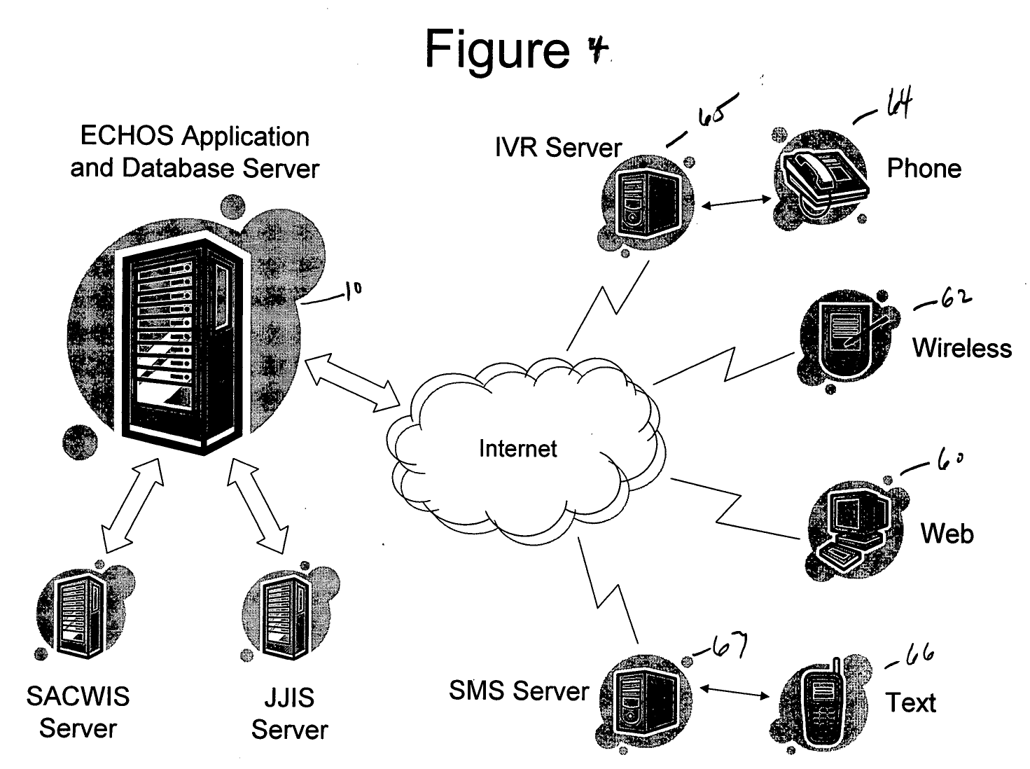

FIG. 4 illustrates the system of present invention from another perspective. Each of the client terminals 11 to 19 of FIG. 1 can be provided in a variety of ways. Any of the client terminals 11 to 19 can be a personal computer 60 connected to the internet 30. Further, each of the client terminals 11 to 19 can be provided by a terminal 62 having wireless connection capabilities. Additionally, each of the client terminals 11 to 19 can communicate with the server 10 by a phone 64 through a server 65. Also, each of the client terminals 11 to 19 can communicate with the server 10 via a device 66 capable of text messaging, through a server 67.

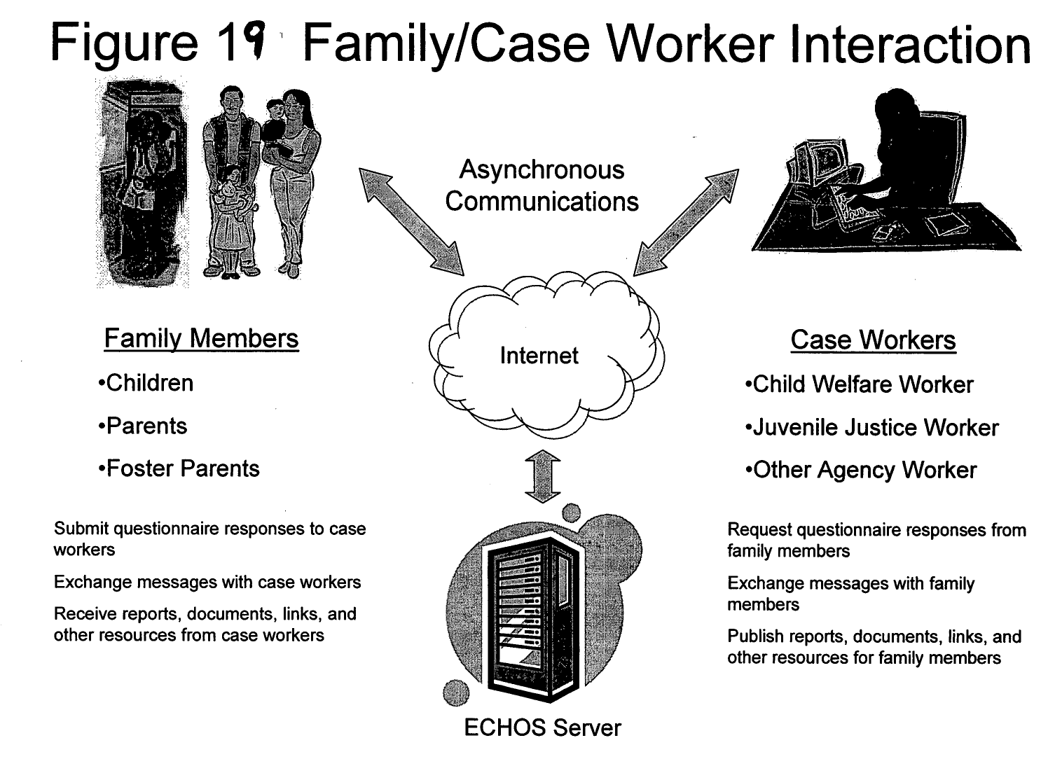

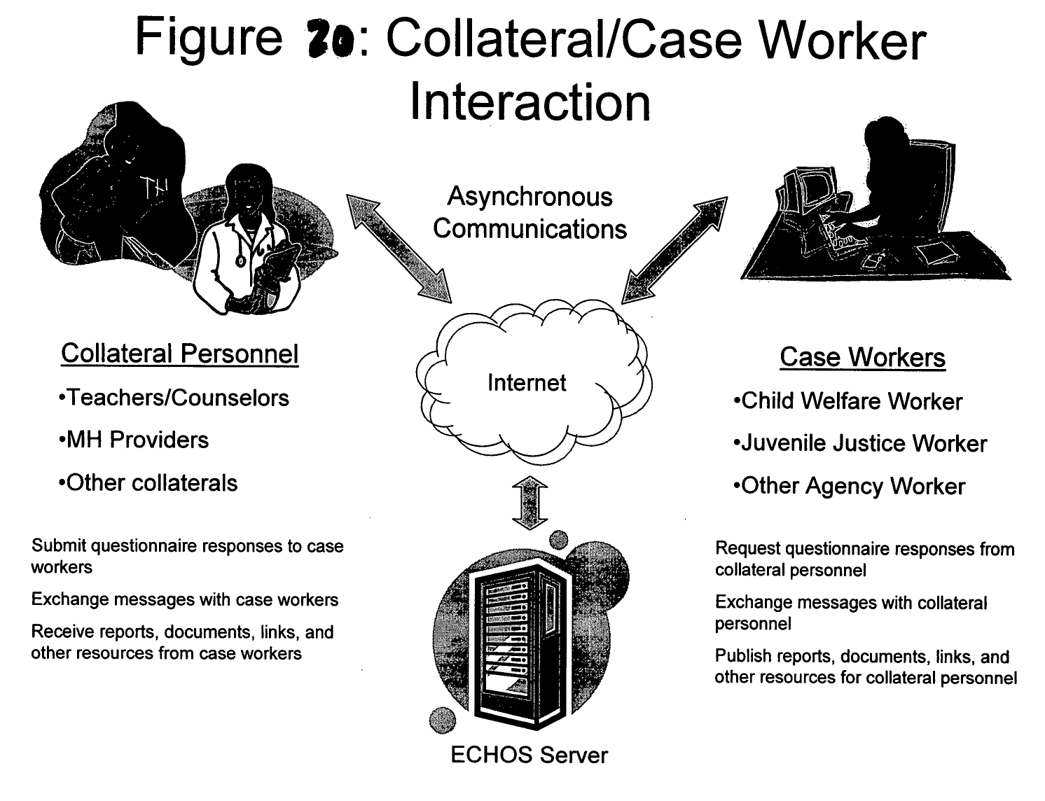

Referring to FIGS. 19 and 20, another aspect of the invention provides for child welfare workers, juvenile justice workers, and other responsible agency workers to asynchronously request and obtain structured and unstructured information on a periodic or hoc basis from various individuals, including children, parents, foster parents, teachers, mental health providers, etc.

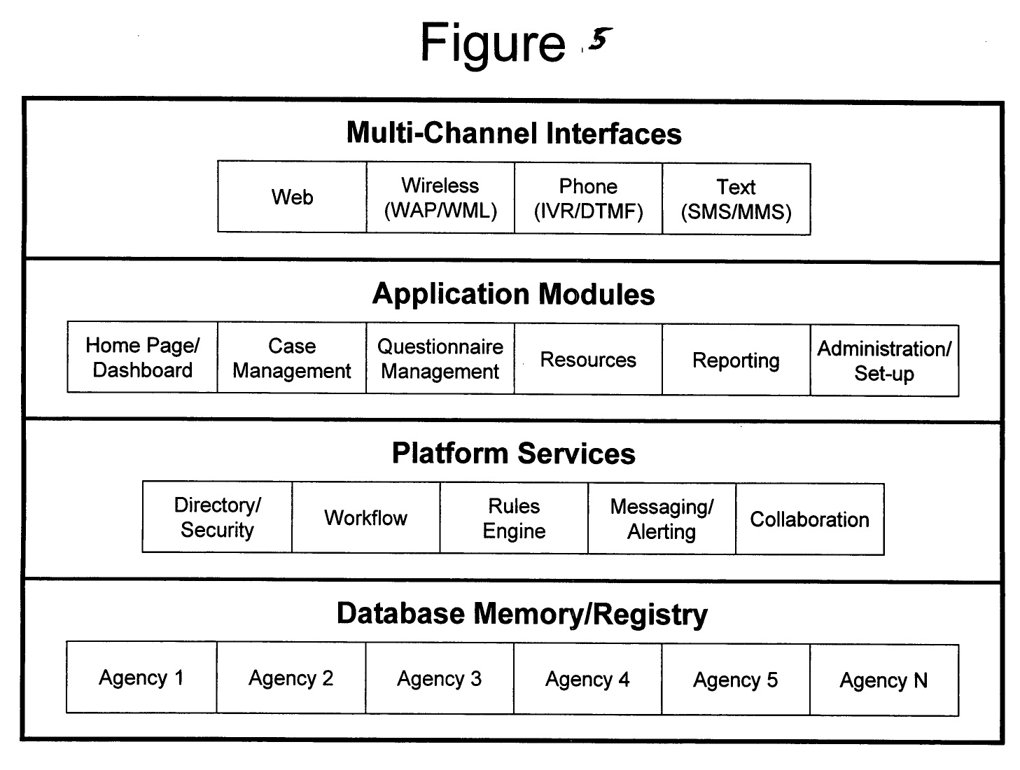

FIG. 5 further illustrates the capabilities of the system in accordance with several aspects of the present invention. On the top level, the system has multi-channel capabilities. These capabilities include web access, wireless access, phone access and text-based access, as was previously discussed. There are a plurality of application modules, including home page, dashboard, case management, questionnaire management, resource management, reporting and administrative functions. There are also a variety of platform services provided, including security, workflow management, a rules engine, messaging/alerting, and collaboration tools. Additionally a database/registry is maintained for each agency involved.

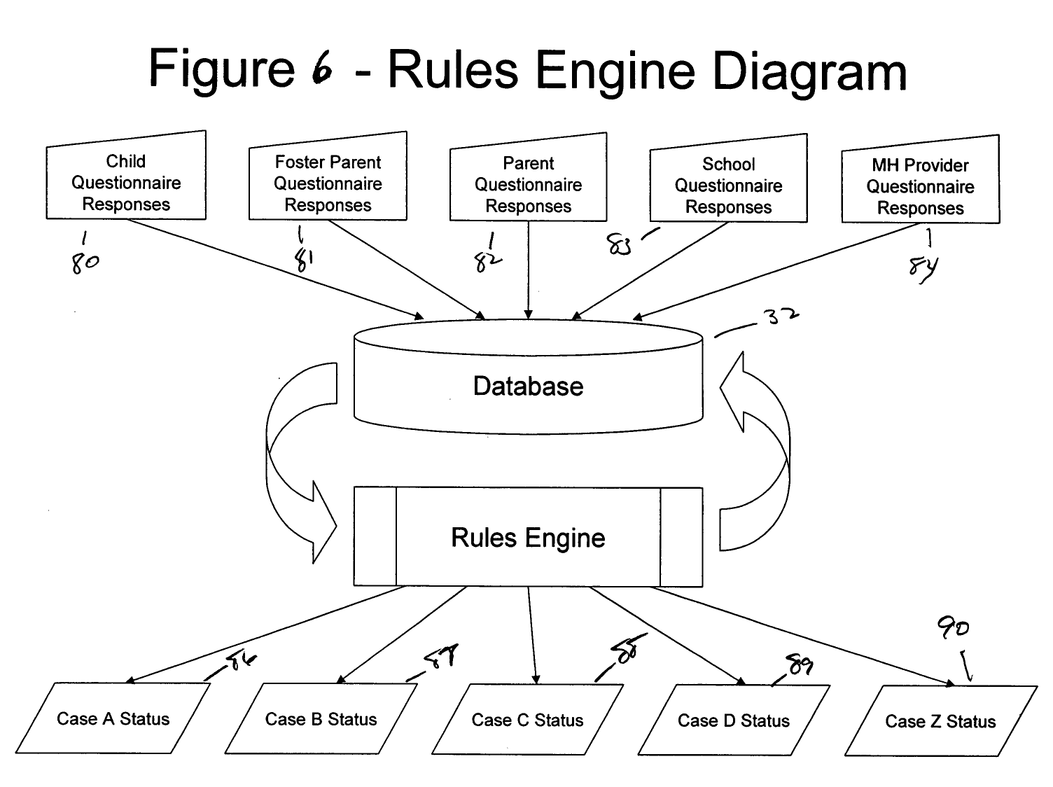

FIG. 6 illustrates a further aspect of the present invention wherein information in the database 32 is analyzed by a rules based engine to determine when issues with respect to one or more children arise. One of the applications provided to each of the users of the system is a questionnaire. The questionnaire asks questions concerning a child, with particular attention to how the child is performing in society. The users answer the questions and send the results to the database 32 where the results are stored.

This process is illustrated in FIG. 6. Questionnaires are provided to the child 80, to a foster parent 81, to one or more parents 82, to the child's school 83 and to a mental health provider 84. These questionnaires can be provided by the system automatically on a periodic basis, via email or other communication means. Alternatively, the users of this system can asynchronously access the questionnaire to update the information maintained in the database 32. Further, access to the questionnaire can be provided by any of the multi-channels means previously discussed.

In accordance with another aspect of the present invention, if a user who is supposed to respond to a questionnaire does not within a specified time limit, the server 10 generates a late message and sends the message to the user. The message is preferably sent by the server 10 over the network 30 to the client terminal 11 to 19 associated with the late responder, as determined by access to the database 32. The rules engine of FIG. 6 determines potential problems with each case (or with each child specified by a case) based on the answers provided in response to the questionnaires 80 to 84 and also classifies the status of each case based on the answers to the questionnaires 80 to 84. Where the answers with respect to a particular child indicate an immediate and important issue or problem, the rules engine assigns that case (or child) an “A status” in step 86. The rules engine also assigns status levels of lesser importance that may not need immediate attention, such as a “B status” in step 87, a “C status” in step 88, a “D status” in step 89, and a “Z status” in step 90. The rules engine therefore takes the answers from the questionnaires and helps assign a priority for each case for a case worker.

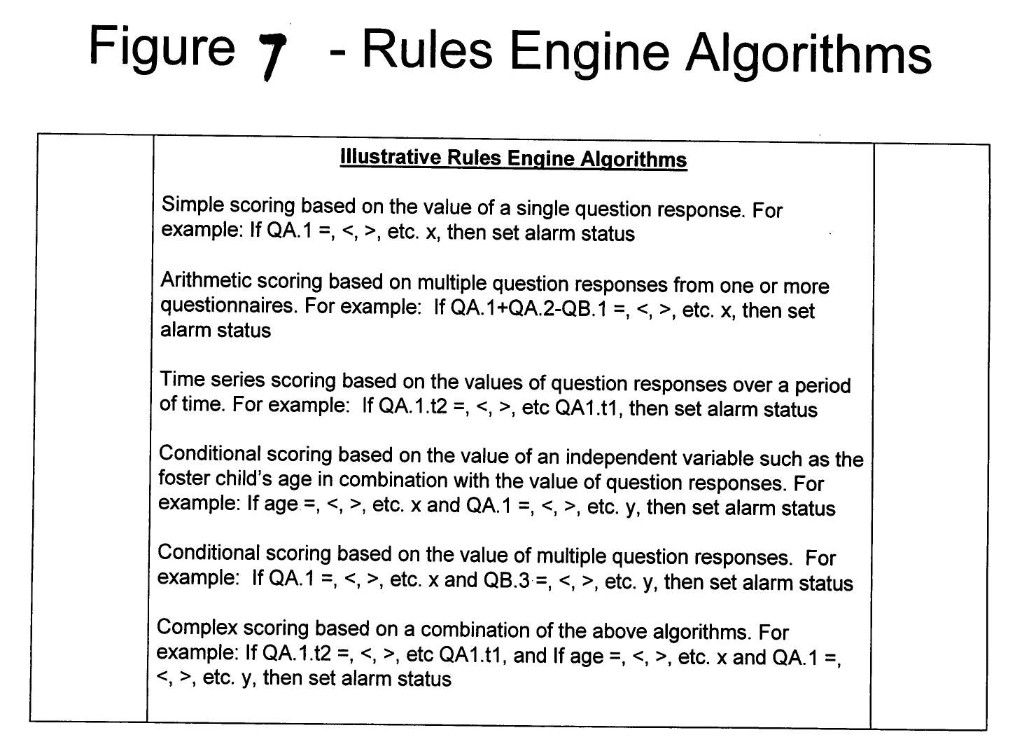

While a variety of rules can be used to assign the status level and the priorities, the rules engine preferably uses various algorithms to make these determinations. FIG. 7 illustrates the various algorithms used in the rules engine to calculate potential problems.

The rules engine in some cases uses simple scoring based on the value of a single question response to determine potential problems or issues. For example: If QA.1=, <, >, etc. x, then set alarm status.

The rules engine can also use arithmetic scoring based on multiple question responses from one or more questionnaires to determine potential problems or issues. For example: If QA.1+QA.2−QB.1=, <, >, etc. x, then set alarm status.

The rules engine can also use time series scoring based on the values of question responses over a period of time to determine potential problems or issues. For example: If QA.1.t2=, <, >, etc QA1.t1, then set alarm status.

The rules engine can also use conditional scoring based on the value of an independent variable such as the foster child's age in combination with the value of question responses to determine potential problems or issues. For example: If age=, <, >, etc. x and QA.1=, <, >, etc. y, then set alarm status.

The rules engine can also use conditional scoring based on the value of multiple question responses to determine potential problems or issues. For example: If QA.1=, <, >, etc. x and QB.3=, <, >, etc. y, then set alarm status.

The rules engine can also use complex scoring based on a combination of the above algorithms to determine potential problems or issues. For example: If QA.1.t2=, <, >, etc QA1.t1, and If age=, <, >, etc. x and QA.1=, <, >, etc. y, then set alarm status.

As an example, if one of the questionnaires indicates that a child is not attending classes, a certain status level and priority can be assigned. If several of the questionnaires indicate that the child is not attending classes and is being a problem at home, another (higher) status level can be set. The status levels will be determined based on experience with all of the various problems encountered and based on the final form of the questionnaires.

FIG. 6 illustrates a typical questionnaire provided to a caregiver. The questionnaire asks certain questions relevant to analyzing a child's behavior and provides for yes/no answers as well as explanations. Similar questionnaires are provided to other users of the system. These other questionnaires can ask the same questions. Alternatively, they can ask similar questions that are slightly different to tailor the question to the specific situation. Thus, the questions asked by the school questionnaire and the mental health provider questionnaire can be slightly different.

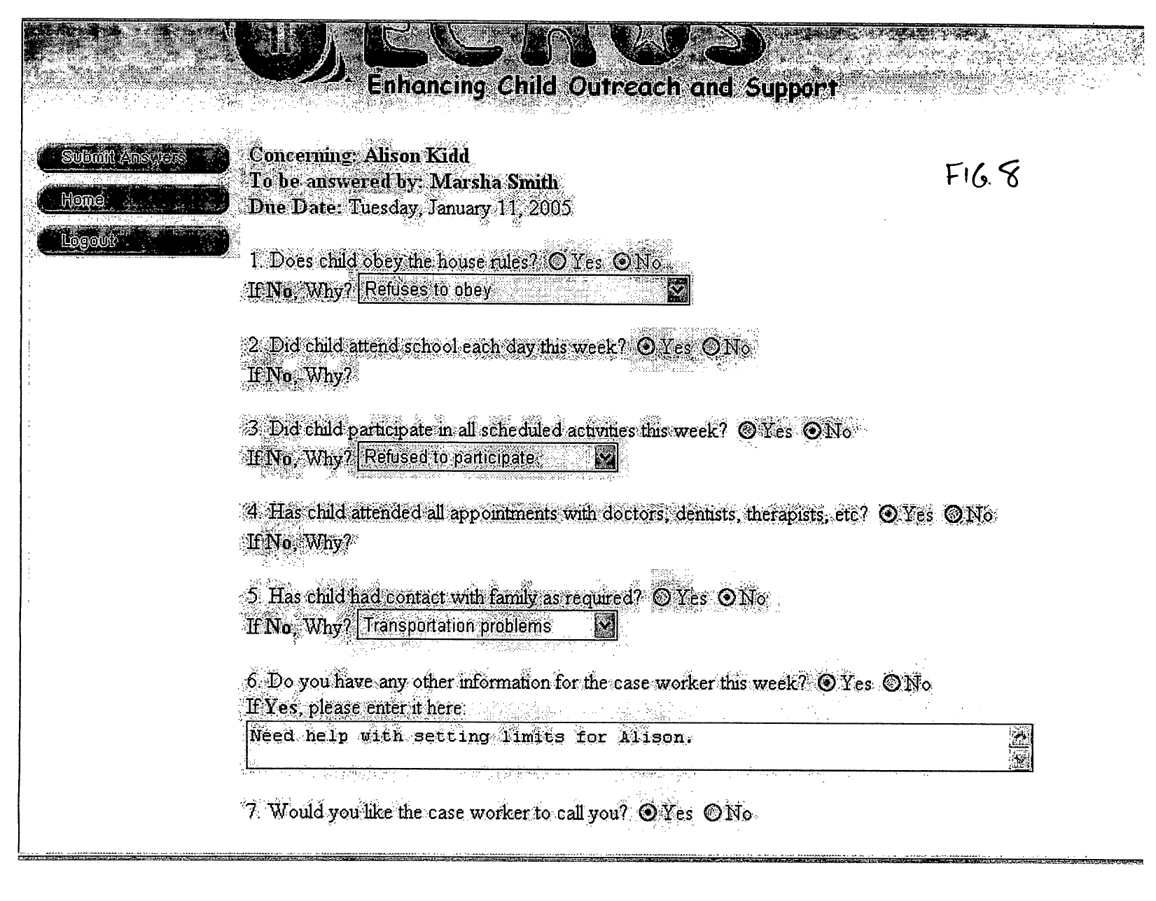

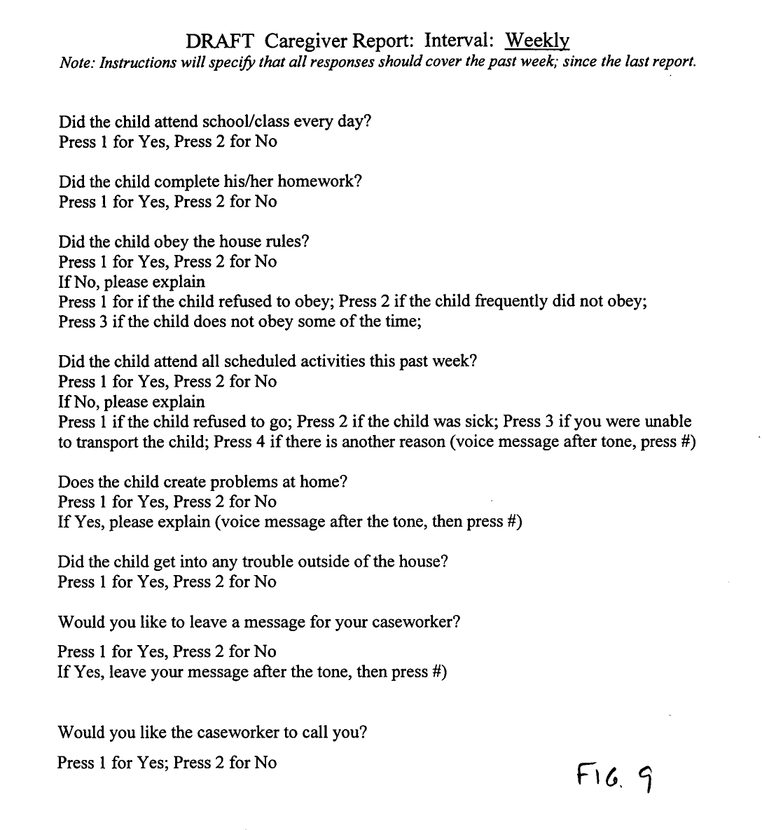

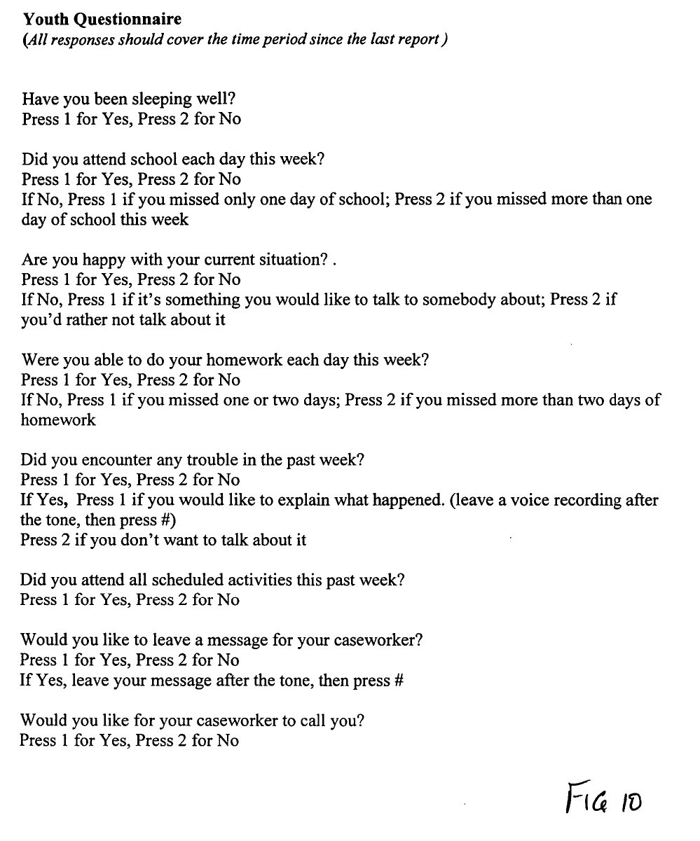

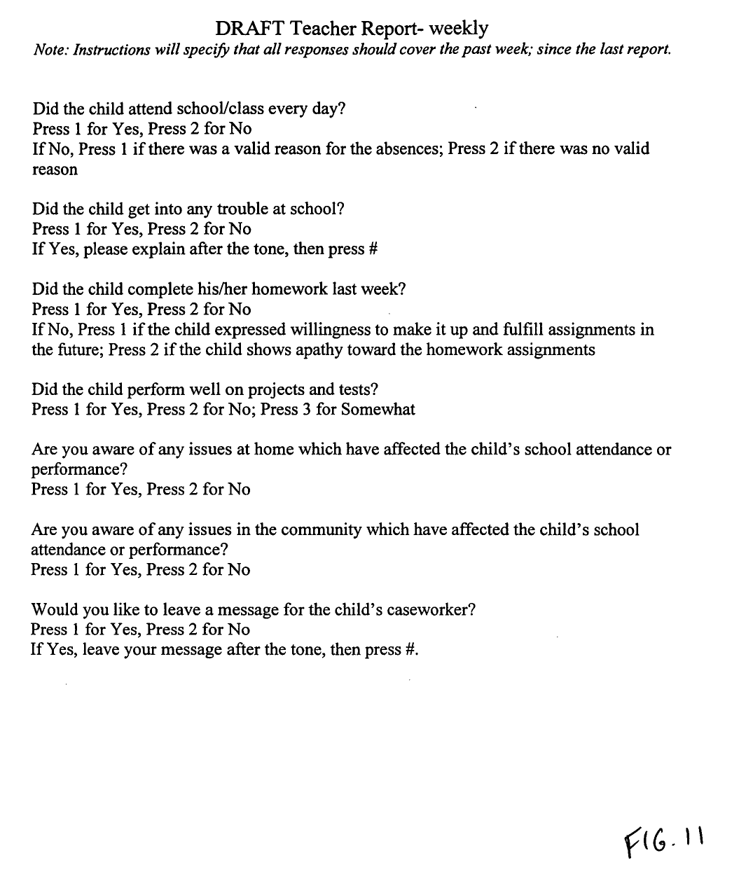

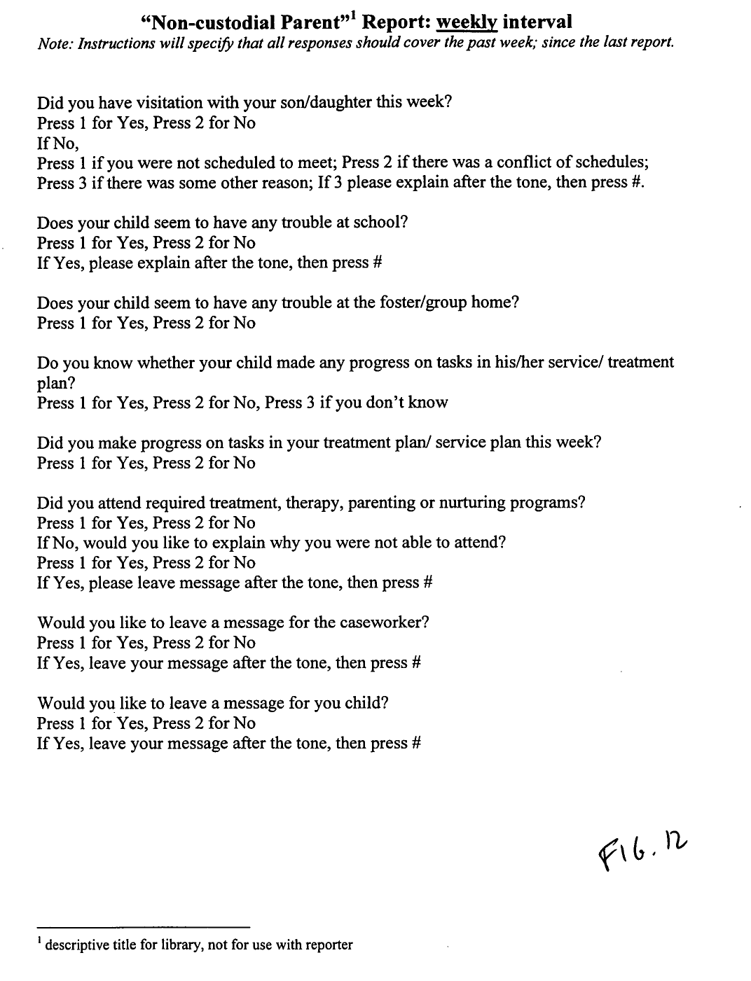

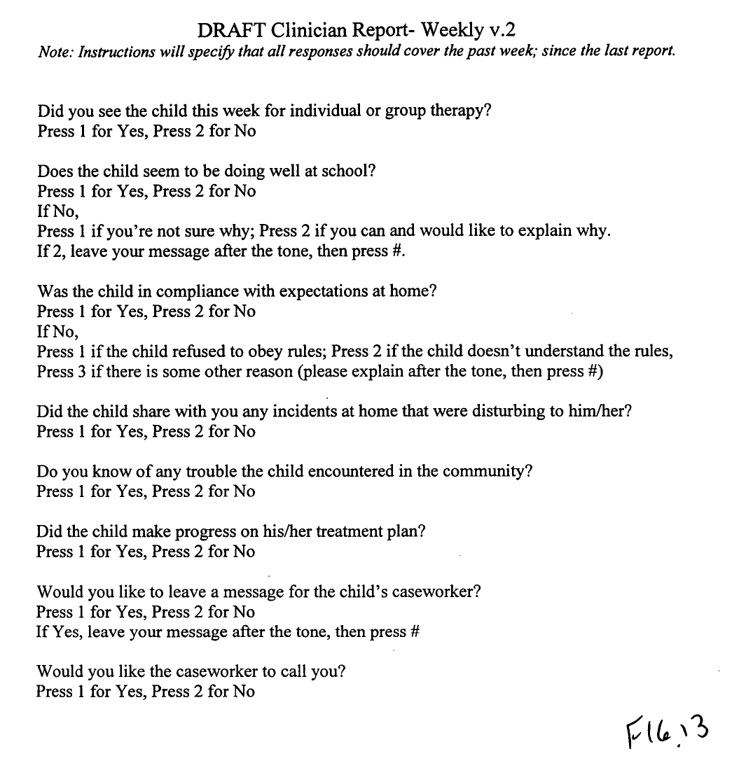

FIGS. 8 TO 13 illustrate examples of some of the various questionnaires that can be sent out by the system. FIG. 8 is an illustrative questionnaire to be completed by a caregiver in the system. FIG. 9 illustrates another form of the questionnaire that can be completed by a caregiver. FIG. 10 illustrates a questionnaire to be completed by a youth in the child welfare system. FIG. 11 illustrates a questionnaire to be completed by a teacher who is teaching a youth in the child welfare system. FIG. 12 illustrates a questionnaire to be completed periodically by a non-custodial parent of a youth in the child welfare system. FIG. 13 illustrates a questionnaire to be completed periodically by a person who is a clinician or mental health provider to a youth in the child welfare system. Each of these questionnaires is provided by the server 30 to the appropriate terminal 11 to 19, preferably by an email communication. The questionnaire asks questions pertinent to the role of the person receiving the questionnaire, and the questions in the questionnaire can be adjusted. The completed questionnaire is sent from one of the terminals 11 to 19 back to the server 30, again preferably by email correspondence. The server 30 retrieves the information from the questionnaire and stores it into the database 32 in association with the child. Referring back to FIG. 6, a processor in the server 10 uses a rules based application using the algorithms set forth above to analyze the information in the database 32 that has been stored from the questionnaire. The rules based application 86 analyzes the data in the database to determine potential issues with a child's situation. The data associated with each child is analyzed and a report 90 to 94 for each child is generated.

The analysis is done periodically by the processor and the reports are generated periodically. Additionally, the analysis can be performed on an asynchronous basis, that is on request by a user authorized by the system to make such a request. Thus, if a case worker has issues with a certain child, the case worker, if authorized (meaning the child is one of his or her assigned cases) then the case worker can request a report. The reports are transmitted via the messaging application to one or more users. In accordance with one aspect of the present invention, the report is transmitted to the case worker only. The case worker can further distribute the report as required. Alternatively, the report can be sent to all interested parties. The messaging application can transmit the report via an email server or by any other communication means.

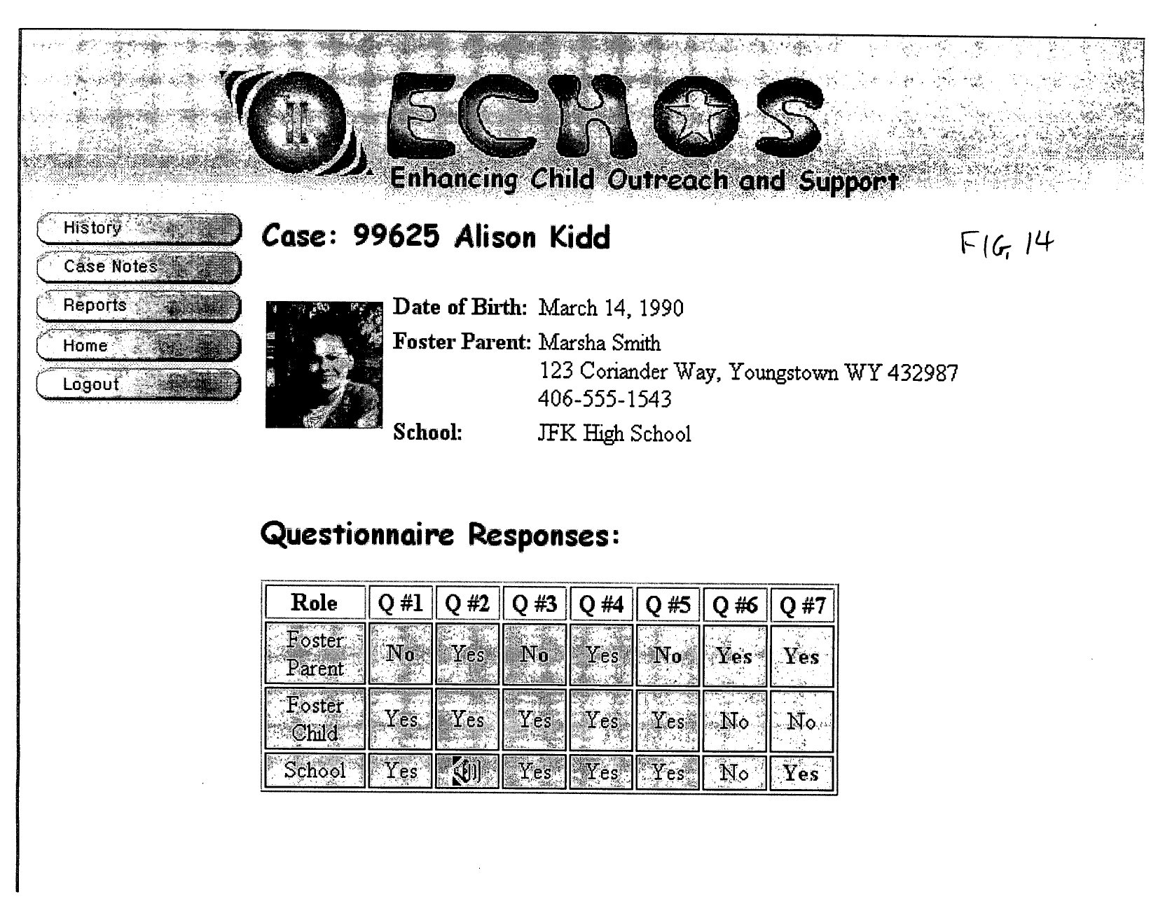

FIG. 14 illustrates a report provided to the case worker, probation officers, court appointed advocate and other authorized agency personnel at the following agencies, including but not limited to, Family Court, Dependency Court, Child Protective Services, Child Welfare Agencies, Foster Care Agencies and other responsible agencies. The answers to each of the questions from various questionnaires are summarized on the report for the case worker to see. The rules based engine generates the report and flags any answer that potentially represents an issue that should be dealt with immediately or when any issue that has potentially dire consequences occurs.

All problematic answers are color coded so they stand out. For example, any answer that is a NO is colored red. All non-problematic answers are a different color, for example, black. Any alarm conditions that are determined from the responses are represented by an alarm icon or any other icon so that the situation stands out.

For example, in response to question 2, the school has indicated a problem on their questionnaire with respect to the attendance of the child at school. The child and the caregiver, however, have not indicated any such problem. This indicates a situation that should be investigated. Thus, the application that generates the report places an icon indicating an alarm status in the report.

Thus, individual case workers preferably do not decide what alarms should be declared. Instead, that is an agency-wide decision determined by the applications based on the responses to the questionnaire. Case workers can, however, set priorities for their cases.

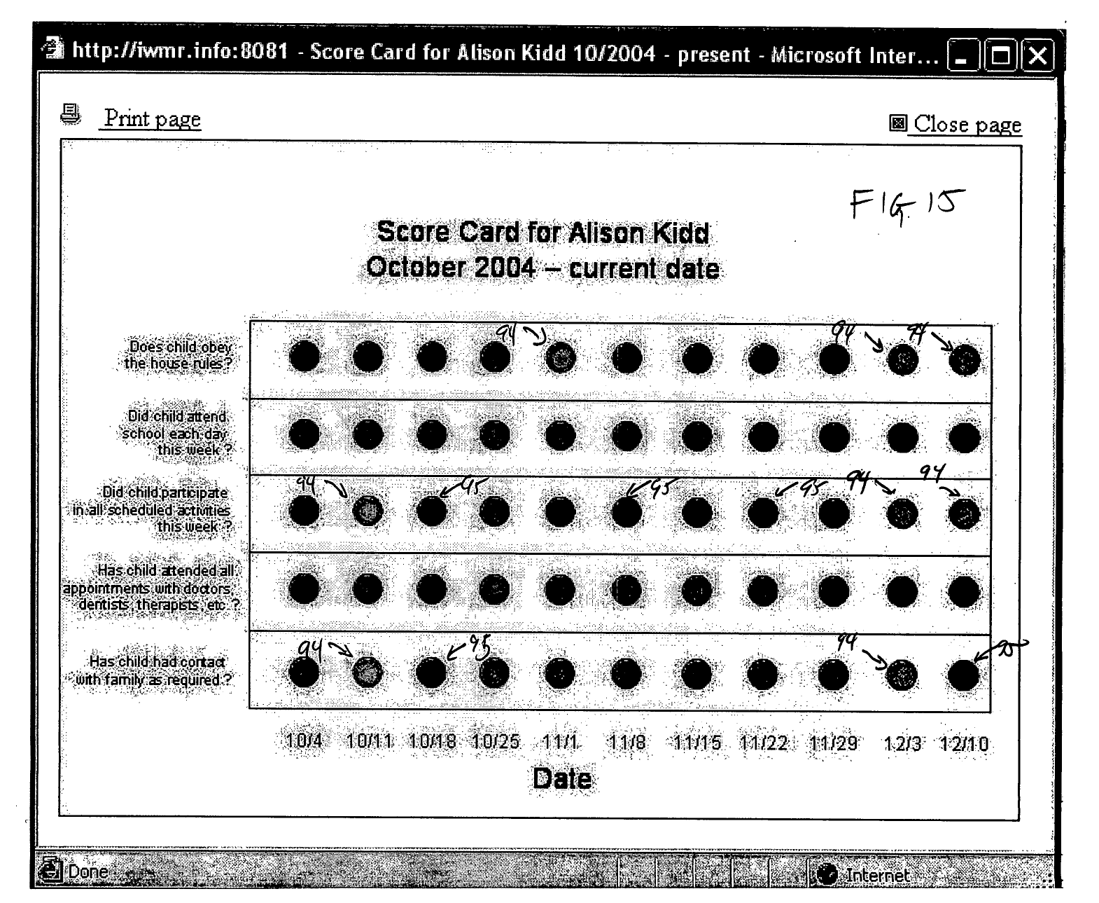

The system can also generate a report card for each child that indicates the child's performance historically. The processor in the server 10 determines a status for each response to the questionnaire. If the responses from each user for a particular question indicates no problem, then a green icon is associated with that question. If the responses from each user for one of the questions indicates a potential problem, then a yellow icon is associated with that question. For example, icons designated 94 are yellow. If the responses from each user for a particular question indicates a serious problem, then a red icon is associated with that question. For example, icons designated 95 are red. Each question from all of the questionnaire's received on a particular date are so analyzed and a report is generated. An example of the report is illustrated in FIG. 15.

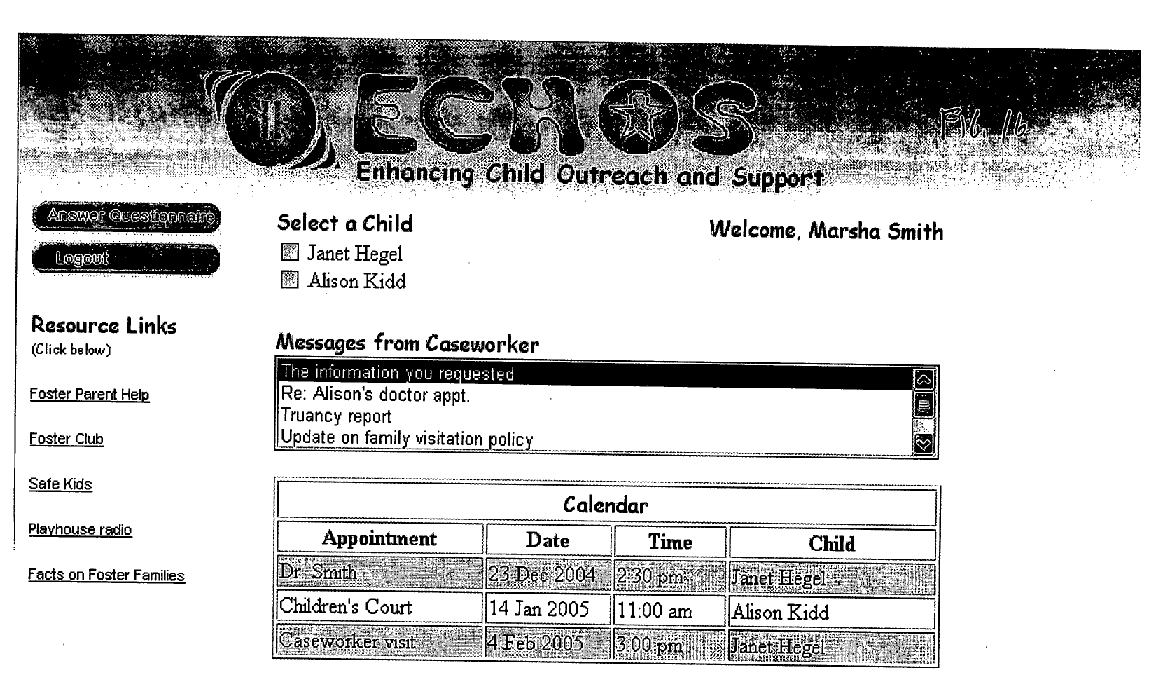

FIG. 16 illustrates a foster parent's home page. The page is provided to a client terminal 11 to 19 by the server 10 after a successful login to the system by a foster parent. The foster parent home page provides a section where messages from the case worker are maintained. It also provides a calendar of events for the child. This information is generated by the server 10 accessing the database 32 to determine which child is associated with the foster parent, which messages are present for the foster parent and what events are associated with the particular child in question.

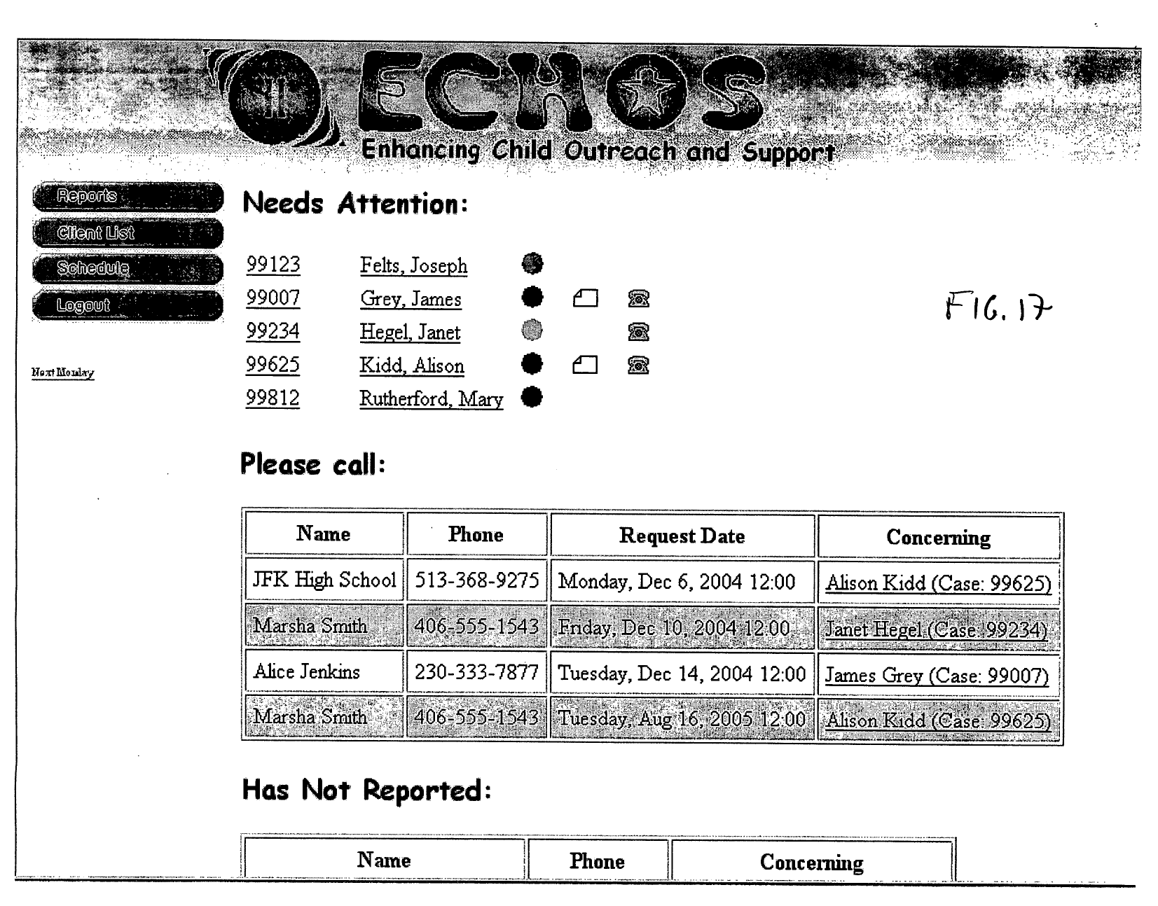

FIG. 17 illustrates a case worker's home page. The page is provided to a client terminal 11 to 19 by the server 10 after a successful login to the system by a case worker. The server 10 retrieves the names of all children under the care of the case worker from the database 32. The server 10 also determines an overall score for each of the children under the supervision of the case worker. The rules engine establishes the score as shown in FIGS. 6 and 7. The application then displays that status on the home page. That score is presented for each child at the top of the page. The score is preferably coded to indicate whether the child is in good shape or needs attention. For example, a child who is performing well may have a green circle next to his or her name. A child who is not performing so well may have a yellow circle next to his or her name. A child having serious problems may have a red circle nest to his or her name.

The case worker's home page also preferably provides contact information for each child as well as a to do list for the case worker. A list of associated people who have not responded to the questionnaire in a timely fashion is also preferably provided.

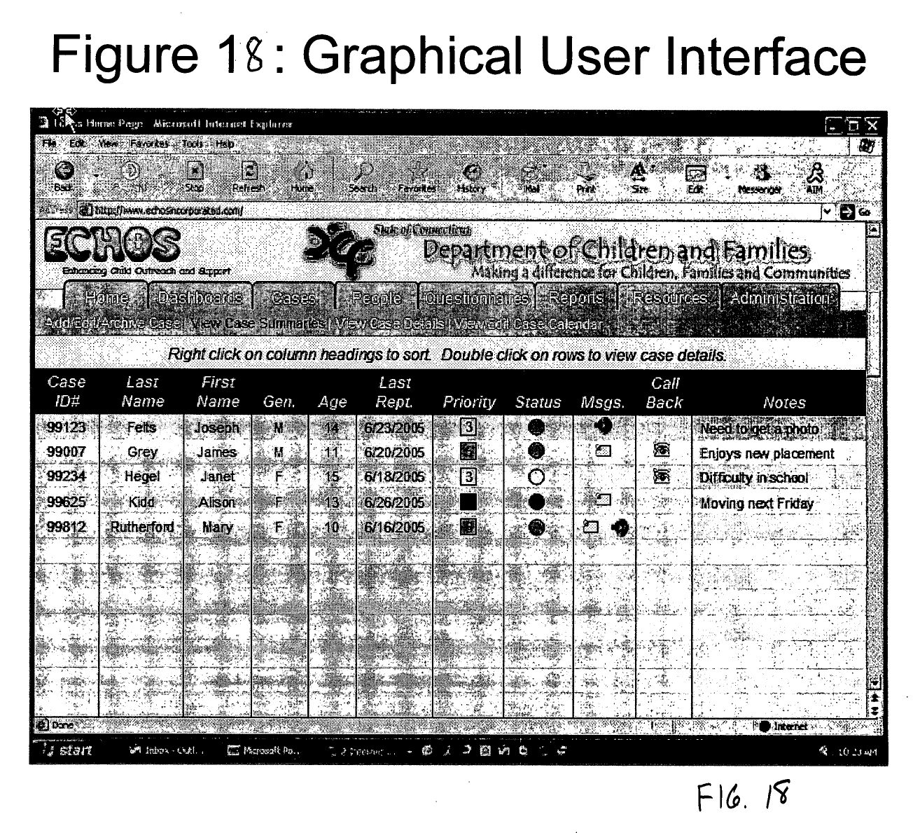

FIG. 18 illustrates a graphical user interface available to each case worker. In addition to the home page, this page provides dashboard reports such as the one shown in FIG. 15, a case summary such as illustrated in FIG. 18, a people page that includes a list of people and their contact information, a questionnaire page where all questionnaires can be accessed, a reports page where all reports can be accessed, a resource page and an administration page.

The case summary page shown in FIG. 18 provides the case ID number, information about a plurality of children, the date of the last report, a priority indication, a status indication, a message indication, a call back request and messages. The case summary page provides a convenient way for a case worker to examine his or her case load and to immediately spot priority issues and cases having problems. This is by virtue of the high priorities and problematic status situations being coded with a different color. For example, red can be used.

FIG. 19 illustrates the relationship between a case worker and the child's family. In the case of FIG. 19, the family includes the child, the child's parents and the child's foster parents. The case worker includes child welfare workers, juvenile justice workers and other social services providers. As illustrated in FIG. 19, the present invention enables asynchronous communications between the family and the case worker. For example, the various member of the family can submit questionnaire responses to case workers, exchange messages with case workers and receive reports, documents, links, and other resources from case workers on their own schedule. All that is required is that they access the server 10 and sign in with a valid ID and password. Similarly the case workers can asynchronously interface with the family members using the present system. Case workers can access the present system at their own convenience to request questionnaire responses from family members, exchange messages with family members and publish reports, documents, links, and other resources for family members. The asynchronous communications allows the various users to communicate on their own convenience and schedule and will provide a major improvement to resource utilization and efficiency in the child welfare systems.

FIG. 20 illustrates the interface between collateral uses and case workers. Collateral workers include teachers/counselors, mental health providers and other collateral workers. Once again, using the present system and methods, the collateral workers and the case workers can communicate asynchronously, on their own schedule and at their convenience. For example, the collateral workers can submit questionnaire responses to case workers without being in direct contact with the case workers. They can exchange messages with the case workers. They can also receive reports, documents, links and other resources from the case workers. The case workers can request questionnaire responses from collateral personnel, exchange messages with collateral personnel and publish reports, documents, links, and other resources for collateral personnel.

All publications cited or referred to in the specification, both patent publications and non-patent publications, are indicative of the level of skill of those skilled in the art to which this invention pertains. All these publications are herein fully incorporated by reference to the same extent as if each individual publication were specifically and individually indicated as being incorporated by reference.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the following claims.

1. A method of collecting, evaluating and sharing information about a plurality of children, comprising:
providing an interface to enter information relating to one of the plurality of children;
storing entered information in a database on a server;
processing the entered information to determine an issue relating to the one of the plurality of children; and
notifying one or more social services departments of the issue.

2. The method as claimed in claim 1, wherein the interface is provided by phone, by wireless, and by the internet.

3. The method as claimed in claim 1, comprising notifying a parent or guardian of the one of the plurality of children about the issue.

4. The method as claimed in claim 1, comprising a first of the plurality of social services departments to communicate with one or more of the plurality of social services departments about the issue.

5. The method as claimed in claim 1, comprising generating a report summarized the status of the plurality of children.

6. The method as claimed in claim 5, wherein the report identifies which of the plurality of children have a priority issue.

7. The method as claimed in claim 6, wherein the report is graphically presented.

8. The method as claimed in claim 5, wherein the report is transmitted to a case manager.

9. The method as claimed in claim 8, wherein the report is transmitted to the one or more social services departments.

10. The method as claimed in claim 9, wherein the report is transmitted to the juvenile justice department.

11. The method as claimed in claim 1, wherein the social services departments include Family Court, Dependency Court, Child Protective Services, Child Welfare Agencies, and Foster Care Agencies.

12. The method as claimed in claim 1, wherein the interface provides a questionnaire about the status of one of the plurality of children.

13. The method as claimed in claim 1, wherein the interface is provided to the one or more social services departments.

14. The method as claimed in claim 13, wherein the interface is provided via the internet.

15. The method as claimed in claim 14, wherein the interface is also provided via a wireless connection.

16. A system for collecting, evaluating and sharing information about a plurality of children, comprising:
a server and a database, the server being connected to the network;
a plurality of client terminals connected to the network;
a first software application through which information relating to one of the plurality of children can be entered through one or more of the plurality of client terminals into the database;
a second software application that processes the information to determine an issue relating to the one of the plurality of children.

17. The system as claimed in claim 16, wherein the second software application transmits a message describing the issue to one or more of the plurality of client terminals.

18. The system as claimed in claim 17, wherein the plurality of client terminals are located in a plurality of social service departments.

19. The system as claimed in claim 16, wherein the plurality of client terminals are located in a plurality of social service departments.

20. The system as claimed in claim 16, wherein the interface is provided by phone, by wireless, and by the internet.

21. The system as claimed in claim 17, comprising notifying a parent or guardian of the one of the plurality of children about the issue.

22. The system as claimed in claim 16, comprising means for generating a report summarized the status of the plurality of children.

23. The system as claimed in claim 22, wherein the report identifies which of the plurality of children have a priority issue.

24. The system as claimed in claim 22, wherein the report is graphically presented.

25. The system as claimed in claim 22, wherein the report is transmitted to a case manager.

26. The system as claimed in claim 22, wherein the report is transmitted to the one or more social services departments.

27. The system as claimed in claim 22, wherein the report is transmitted to the juvenile justice department.

28. The system as claimed in claim 19, wherein the social services departments include Family Court, Dependency Court, Child Protective Services, Child Welfare Agencies, and Foster Care Agencies.

29. The system as claimed in claim 16, wherein the first software application provides a questionnaire about the status of one of the plurality of children.

30. The system as claimed in claim 16, wherein the network is the internet.

31. The system as claimed in claim 17, wherein one of the plurality of client terminals is a wireless device.
